(19) United States
(12) Patent Application Publication
(10) Pub. No.: US 2003/0020840 A1
(43) Pub. Date: Jan. 30, 2003

(54) Mobile video-audio switching system

(76) Inventors: William A. Hays, Oceanside, CA (US); Claudio R. Laraia, Bronx, NY (US)

Correspondence Address: CHARLES C. LOGAN II, 8282 UNIVERSITY AVENUE, LA MESA, CA, 91941, US

(21) Appl. No.: 09/919,528

(22) Filed: Jul. 30, 2001

(51) Int. Cl. H04N 5/44

(52) U.S. Cl. 348/837

(57) ABSTRACT

A mobile video-audio switching system mounted in a motor vehicle powered by the vehicle's 12V DC battery. A mobile video-audio switch(MVAS) device is mounted in the motor vehicle and it has four different video-audio input devices electrically connected thereto and four liquid crystal display(LCD) screens are also mounted in the motor vehicle. Four separate wireless remote control transmitters send individual signals to the MVAS device directing that signals from any of the different video-audio input devices be sent to any of the individual LCD screens. Individuals viewing the respective LCD screens can receive an audio input through a headset that they may wear or they may receive the audio signals through the radio and speaker system already installed in the motor vehicle.

This patent application hereby claims priority of the provisional patent application serial no. filed Jul. 28, 2000.

### BACKGROUND OF THE INVENTION

The invention relates to a mobile video-audio switching system that is installed in a motor vehicle, and more specifically to one having a plurality of different video-audio input devices, a plurality of liquid crystal display(LCD) screens mounted in the vehicle and a mobile video-audio switch(MVAS) that allows video-audio signals to be displayed on any of the LCD screens from any of the respective video-audio input devices.

The mobile video-audio markets have been expanding rapidly with the advent of new technological developments in low cost compact LCD screens, CDs, computer games and DVDs. In many cases multiple LCD screens and multiple input devices such as computer games, VHS player, DVD video players and even rear facing cameras are being installed and used in a single motor vehicle. Each of the LCD screens is directly wired to only one of the individual input devices and they are controlled by their own individual controller that is directly wired to the input video-audio device that in turn is directly wired to the LCD screen. The use of a splitter to transmit video-audio signals from a single audio-video input device to a pair of LCD screens is the most advanced technology of the prior art use of LCD screens in motor vehicles.

The use of wireless remote control transmitters has been used by Lavelle et al in U.S. Pat. No. 5,469,151 for use in a car alarm system. The use of wireless remote control transmitters for any other use in motor vehicles is not presently known.

It is an object of the invention to provide a novel mobile video-audio switching system that can be installed in motor vehicles.

It is also an object of the invention to provide a novel mobile video-audio switching system that can be operated by wireless remote control transmitters.

It is another object of the invention to provide a novel mobile video-audio switching system that has four video-audio input devices and four LCD screens and a switching device that allows video-audio signals from any of the input devices to be sent to any of the respective LCD screens.

It is an additional object of the invention to provide a novel mobile video-audio switching system that can be easily installed in a motor vehicle.

It is a further object of the invention to provide a novel mobile video-audio switching system that can use RF or IR wireless remote control transmitters.

### SUMMARY OF THE INVENTION

The mobile video-audio switching system has been designed to be installed in a motor vehicle having a DC power source. It has a mobile video-audio switch(MVAS) device that is powered by the motor vehicle's battery. There are four video-audio input devices electrically connected to the MVAS device and there are four LCD screens mounted in the motor vehicle. Individual viewers of the respective four LCD screens each have their own wireless remote control transmitter that is capable of selecting any of the four input device video-audio signals and directing these signals to any of the output video-audio LCD screen by their respective wireless remote control transmitters that may use either RF or IR signals. Some examples of input video-audio devices would be a DVD player, a VCR player, a computer game console and a rear view camera.

The individual wireless remote control transmitters are battery powered and have a micro-processor in their housing. Each transmitter has three control buttons electronically connected to the micro controller. One of the control buttons is a scroll up button. Another is a scroll down button and the third one is a select button. The micro controller in each of the transmitters and the micro controller in the MVAS are programmed to store a unique code for each individual wireless remote control and also for each LCD screen in a non-volatile memory. Control button 1 on the wireless remote control device will turn the LCD screen on and off and this button also scrolls upwardly. Button 2 will scroll down through each of the input devices for selection and display on the LCD screen. Button 3 will be used to select the input video-audio device that the viewer wants to view.

The respective input video-audio devices produce audio signals and these are electrically connected to the MVAS device. Each of the input video-audio devices also has an internal transmitter that can send its audio signals directly to a headset that the viewer might wear and this connection would be a wireless connection. The MVAS device also has a transmitter for sending a wireless audio signal to the radio installed in the motor vehicle and its speaker system so that any of the input video-audio devices can be played directly on the radio's speaker system.

### DESCRIPTION OF THE DRAWINGS

FIG. 1 is a front perspective view of the MVAS;

FIG. 2 is a front perspective of one of the wireless remote control transmitters;

FIG. 3 is a block diagram of the mobile video-audio switching system mounted in a motor vehicle;

FIG. 4 is a block diagram of the MVAS system;

FIG. 5 is a block diagram of the transmitter flow chart; and

FIG. 6 is a block diagram of the receiver flow chart.

### DESCRIPTION OF THE PREFERRED EMBODIMENT

The mobile video-audio switching system will now be described by referring to FIGS. 1-6 of the drawings.

FIG. 1 is a front perspective view of the MVAS device and it is designated numeral 10. It has a housing 12 that is approximately 5″×7″×1.5″ and may be installed in the trunk or under the seat of a motor vehicle 14. There are input jacks 16 on at least two of the side walls. The function of some of these input jacks will be described later.

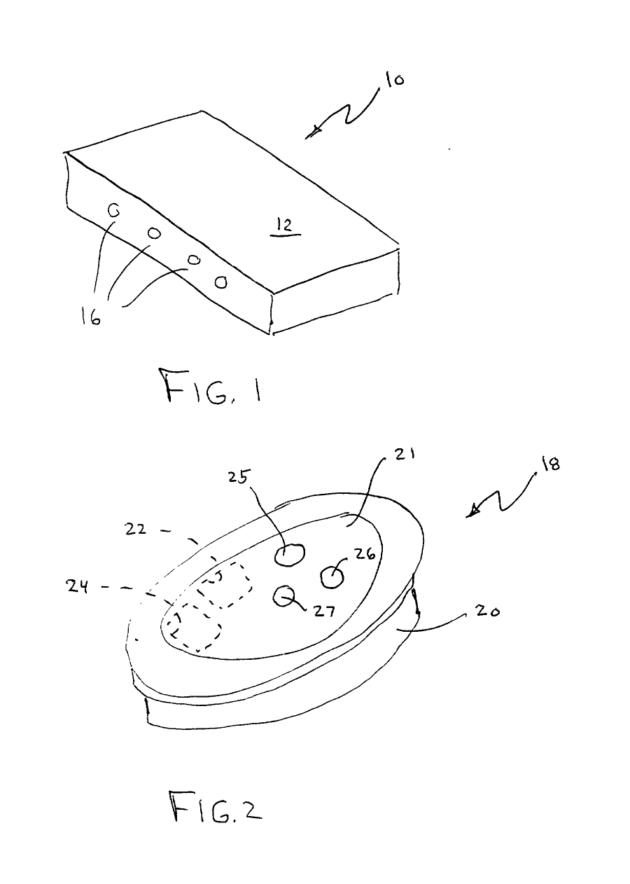

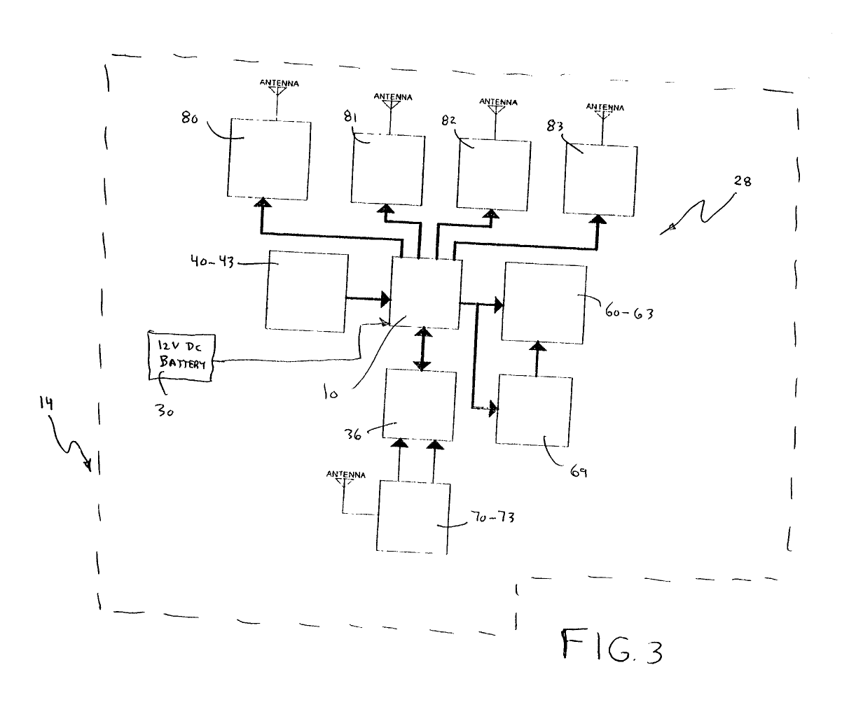

One of the wireless remote control transmitter devices 18 is illustrated in FIG. 2. It has a housing 20 having a cover 21. Inside housing 21 is mounted a DC battery power source 22 that is connected to a micro-controller 24. Control buttons 25-27 are mounted in cover 21 and they are electrically connected to micro processor 24. The operation of the wireless remote control transmitter devices 18 will be described later in more detail.

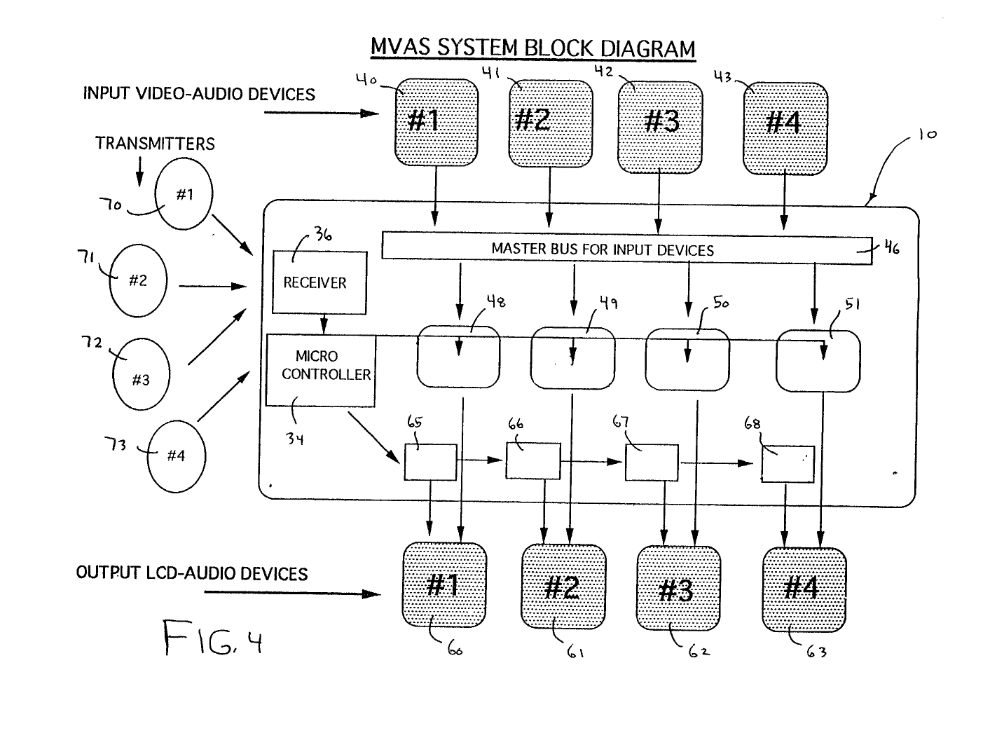

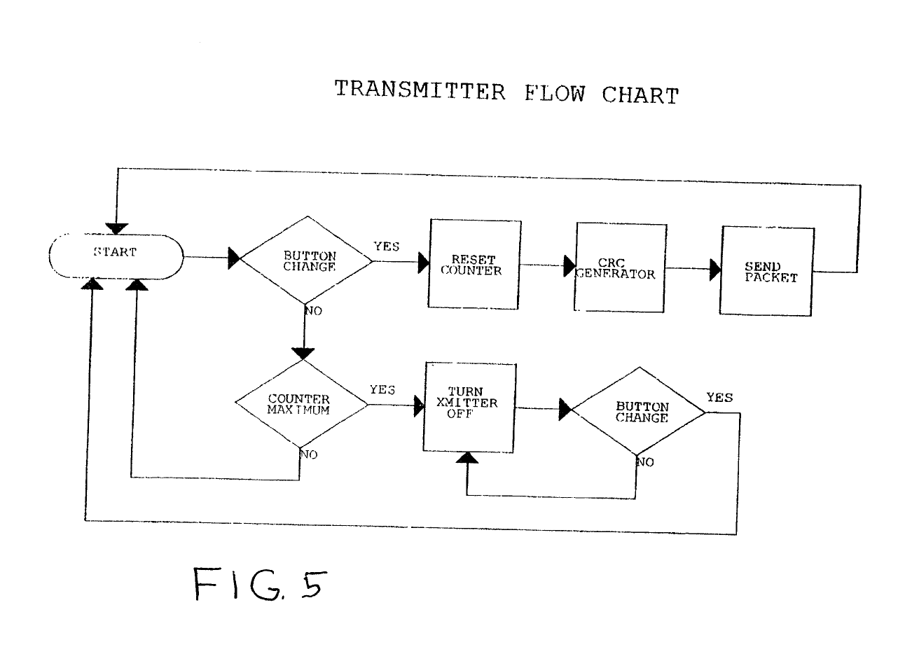

The mobile video-audio switching system 28 is best understood by referring to FIGS. 3 and 4. It is mounted in motor vehicle 14 and powered by the motor vehicle's 12V DC battery 30. The MVAS 10 has a printed circuit board having a micro-controller 34 and a receiver 36 electronically connected in an integrated circuit(IC) on the printed circuit board. Input video-audio devices 40-43 are connected by electrical wires to their respective input jacks 16. Input video-audio device 40 is a DVD player and input video-audio device 41 is a computer game console. Other input video-audio devices are the VCR player 42 and the rear view camera 43. All the input video-audio devices are connected through their respective jacks to a master buss 46. Video switches 48-51 are electronically connected micro-controller 34. Output LCD screens 60-63 are connected directly by electrical wires to the respective video switches 48-51 to provide audio paths from the respective video-audio input devices 40-43. Micro-controller 34 is electronically connected to the respective transistors 65-68 that send power to the respective LCD's 60-63. These audio signals may be in the form of radio frequency(RF) or infrared(IR) waves. Wireless remote control transmitters 70-73 are used by the individual viewer's and they send their signals to receiver 36. These signals indicate which input video-audio device they wish to view on their personal LCD screen. MVAS device 10 is powered by battery 30 of motor vehicle 14. The MVAS device 10 is also electrically connected to individual input video-audio devices 40-43 to electrically turn them on and off. Audio amplifier 69 regulates the power of the audio signals to the LCD screens 60-63. The audio signal for any of the input video-audio devices 40-43 can be transmitted to the motor vehicle radio and its speaker system through transmitter 80. Transmitters 81-83 may send RF or IR signals to the respective viewer's headsets for the respective LCD screens 60-63.

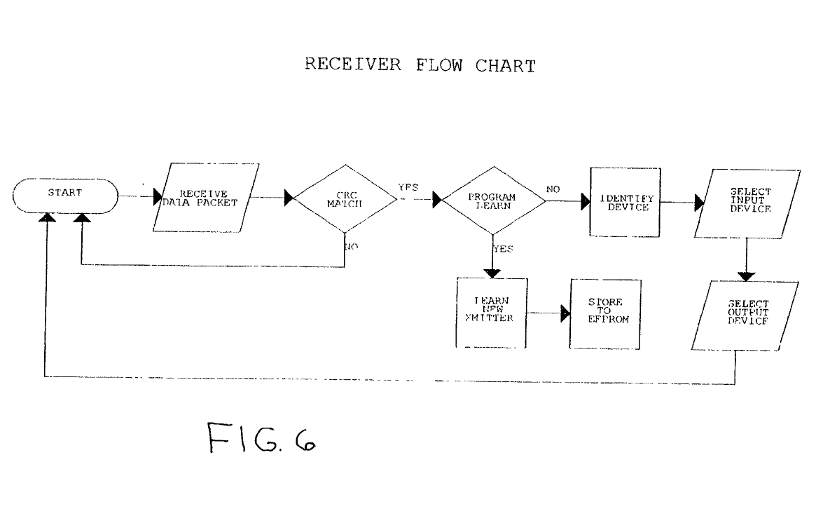

The flow chart for the respective wireless remote control transmitters 70-73 is illustrated in FIG. 5. The manner in which they function is as follows. Each wireless remote control transmitter uses a micro controller for packet and CRC(cyclical redundancy check) generation, control buttons to send unique packets and a counter to control maximum transmitter on the air. This is a FCC rule (part 15.231), turns off transmitter if a control button held down unintentionally. The following is a description of the transmitter flow chart.

START: starts program.

BUTTON CHANGE: looks to see if a button has been pushed.

RESET COUNTER: resets counter.

CRC GENERATOR: generators CRC.

SEND PACKET: sends packet.

COUNTER MAXIMUS: sets counter to maximum.

TURN XMITTER OFF: turns transmitter off after 5 seconds.

The flow chart for receiver 36 is illustrated in FIG. 6. The manner in which it functions is as follows. The MVAS uses a micro controller for decoding unique received packet data from the receiver (sent by the wireless remote control transmitter). Performs a CRC (cyclical redundancy check) to confirm that the packet received is correct. In the event that a transmitter is lost, the micro controller can learn a new transmitter and store it in EEPROM. The micro controller identifies and input and output device and selects that device. The following is a description of the receiver flow chart.

START: starts program.

RECEIVE DATA PACKET: receives packet from RF receiver.

CRC MATCH: (cyclical redundancy check) checks to see if the packet received is the same that was transmitted.

PROGRAM LEARN: go to code learn mode and all transmitters unique codes can be learned sequentially.

STORE TO EEPROM: stores transmitters unique codes to EEPROM.

IDENTIFY DEVICE: identifies input and output device.

SELECT INPUT DEVICE: selects input audio or video device

SELECT OUTPUT DEVICE: selects output audio or video device.

what is claimed:

1. A mobile video-audio switching system comprising:
a motor vehicle;
a D.C. power source mounted in said motor vehicle;
a mobile video-audio switch (MVAS) device mounted in said motor vehicle; said MVAS device comprising;
a) an integrated circuit (IC) mounted on a printed circuit board; said IC having a plurality of input jacks, each for receiving an electrical wire connection from a separator video/audio input device;
b) a micro controller electronically connected to said IC;
c) a receiver electronically connected to said micro controller for receiving wireless signals from a plurality of wireless remote control transmitters;
a plurality of different video-audio input devices electrically connected to said respective input jacks of said MVAS device;
a plurality of liquid crystal display (LCD) screens in said vehicle; and
a plurality of wireless remote control transmitters each having means for sending separate signals to said receiver in said MVAS device directing that a video signal from one of said video-audio input devices be sent to each of said respective LCD screens.

2. A mobile video-audio switching system as recited in claim 1 wherein there are at least four different video-audio input devices electrically connected to at least four input jacks of said MVAS device.

3. A mobile video-audio switching system as recited in claim 2 wherein there are at least four LCD screens in said vehicle.

4. A mobile video-audio switching system as recited in claim 3 wherein one of said video-audio input devices is a DVD player.

5. A mobile video-audio switching system as recited in claim 3 wherein one of said video-audio input devices is a VCR player.

6. A mobile video-audio switching system as recited in claim 3 wherein one of said video-audio input devices is a computer game console.

7. A mobile video-audio switching system as recited in claim 3 wherein one of said video-audio input devices is a rear view camera.

8. A mobile video-audio switching system as recited in claim 2 wherein said MVAS has a master buss for said video-audio input devices.

9. A mobile video-audio switching system as recited in claim 2 wherein there are at least four wireless remote control transmitters.

10. A mobile video-audio switching system as recited in claim 1 wherein each of said LCD screens have a receiver for receiving video signals from said MVAS device.

11. A mobile video-audio switching system as recited in claim 1 wherein said MVAS device has means for electrically transmitting audio signals from each of said video-audio input devices to each of said LCD screens.

12. A mobile video-audio switching system as recited in claim 1 further comprising a plurality of headsets and said MVAS device has wireless means for transmitting audio signals from each of said video-audio input devices to each of said respective headsets.

13. A mobile video-audio switching system as recited in claim 1 further comprising a radio with a vehicle speaker system mounted in said motor vehicle and said MVAS device has means for transmitting audio signals from each of said video-audio input devices to said radio and said vehicle speaker system.

14. A mobile video-audio switching system as recited in claim 1 wherein said wireless remote control transmitters have a D.C. battery power source connected to a micro controller.

15. A mobile video-audio switching system as recited in claim 14 wherein each of said wireless remote control transmitters has a plurality of control buttons electronically connected to said micro controller.

16. A mobile video-audio switching system as recited in claim 15 wherein one of said control buttons is a scroll up button, one of said control buttons is a scroll down button and one of said control buttons is a select button.
